(19) United States
(12) Patent Application Publication
(10) Pub. No.: US 2025/0297598 A1
(43) Pub. Date: Sep. 25, 2025

(54) System for airflow energy conversion as an attachment integration in solar plants for additional supply of electrical energy

(71) Applicant: Jens BOHL, Glienicke Nordbahn (DE)

(72) Inventor: Jens BOHL, Glienicke Nordbahn (DE)

(21) Appl. No.: 18/860,809

(22) PCT Filed: Apr. 27, 2022
(86) PCT No.: PCT/EP2022/061275

§ 371 Date: Oct. 28, 2024

(51) Int. Cl. F03D 9/00; F03D 3/00; F24S 80/00; H02K 7/18; H02S 10/12; H02S 40/44

(52) U.S. Cl. CPC F03D 9/007; F03D 3/005; H02K 7/183; H02S 10/12; H02S 40/44; F05B 2220/708; F24S 80/00

(57) ABSTRACT

The invention relates to a system for airflow energy conversion as an attachment integration in solar plants (1) for additional supply of electrical current. The invention relates to the concept of integrating or attaching an airflow energy system directly to existing or newly designed solar plants (1). The airflow energy system uses any airflows acting on the installation site. Wind, heat absorption energy of the utilised solar plant and airflows resulting from thermals in the immediate surroundings are optimally used for this purpose. In this way, additional electrical energy is generated and added to the electrical energy already obtained from solar energy. With this invention, the energy yield at solar plants is increased. The direct combination of the airflow system with a solar plant (1) forms an overall system which requires no additional investment in site area, while using only one system controller.

### TECHNICAL FIELD

In order to meet the large energy needs of the world's population, solutions for generating electricity have been constantly being developed over the past few decades through the construction of solar systems (1), wind turbines and other new energy generation concepts. These so-called green energy generation concepts are to be further developed as an alternative to nuclear power or the burning of fossil fuels in order to stop global warming.

The already widespread solar energy systems (1) can be found in a large number of private homes, commercial buildings, municipal functional buildings and also in large solar energy field systems known as solar parks.

Solar systems (1) are available as surface modules for generating electricity, as solar thermal systems for generating thermal energy and also as a combination of solar thermal and solar power generation systems.

All solar systems (1) are installed on a supporting structure or framework (2), which must be adapted to the installation task and its environment. In order to reduce the manufacturing costs of solar systems (1), the majority of manufacturers now use standardized frame systems (2) for solar modules or solar thermal systems.

### PRIOR ART

In order to achieve ever more efficient electricity generation, concepts for combining a solar system (1) with a wind turbine have been around for several years. This means that only one energy storage system or the energy feed into the power grid is operated via an overall control management system.

The two energy generation systems are mainly connected via adapter cables (Y-cables) in an overall energy management and storage system.

The solution concepts already in widespread use combine solar systems with wind turbines consisting of horizontal axis wind turbines with at least three blades. In rare cases, concepts with combinations of solar energy systems and vertical axis wind turbines are offered.

These concepts combine energy generation systems from at least two separate installation sites, the solar system (1) and the wind turbine.

There is another well-known concept that describes a combination of solar energy generation and wind energy generation. These systems are exclusively special constructions that accommodate solar modules on a special support structure. In addition, at least one radial turbine is positioned below the support structure, which can only be operated via integrated outflow openings.

This system concept describes and shows in the published drawings, exclusively a separate or own stand system as a special construction. This system concept is aimed at a self-sufficient solution and can be integrated into both existing solar systems (1) and new solar systems (1) to be installed which are based on the conventional standard constructions and frameworks (2).

### BRIEF DESCRIPTION OF THE INVENTION

My invention is the idea of providing an airflow energy system with drum wheel generators (5) as an attachment integration for all concepts of solar systems (1). By making optimum use of the airflow energies acting at the installation site, additional electrical energy is fed into the now combined overall system. The combined solar and airflow energy thus increases the energy balance of the overall system. The invention is the concept of utilizing all the airflows in the immediate vicinity as well as the self-emitting absorption flows at the solar system by directly attaching or integrating the airflow energy system. The airflow energy system can be ideally adapted to any support or stand construction of solar systems (1) using appropriate adapters (9). Integration therefore takes place directly on the framework (2) of the solar panels (1) and is combined therewith.

### Technical Object

The invention is designed accordingly to be easily integrated on a solar system (1) with frame construction (2). The integration can be installed on solar thermal systems as well as on photovoltaic systems (1) using suitable adapter systems (9). Retrofitting the invention to existing solar systems (1) is therefore very easy, regardless of the size, type, and location.

The modular design of the invention, in particular the drum wheel generator (5), utilizes the principle of converting airflow energy into rotary motion, which has been known for centuries. For example, this principle is also already used in windmills. In order to generate electricity with the invention via the drum wheel generator (5), magnets are attached to the rotor axis (4) of the drum wheels (6). The coils required for the generator are located in the bearing blocks (3). The drum wheel generator (5) is therefore able to convert the kinetic energy of the airflow into electrical energy.

### Technical Solution

In order for the operating concept of the invention to be able to convert all airflows acting at the installation site into electrical current, the invention must be mounted primarily above the solar system.

The invention utilizes all usable wind currents that act on the surface of the solar system (1), as well as wind currents that are usable for the system concept in the immediate vicinity of the installation site.

Furthermore, the invention utilizes all usable heat absorptions which are generated by the operation of the solar system (1) itself, but also heat flows which act on the solar system (1) due to the irradiation of solar energy.

The invention also utilizes all usable airflows from the thermal energy in the immediate vicinity of the system installation.

The system concept of the invention is able to be installed at all positions of the framework (2) of solar systems (1). The invention can be installed at least on the vertical longitudinal side ([FIG. 1]) or horizontal transverse side ([FIG. 2]) above the solar system (1). However, mounting is also possible on any other side or on all sides ([FIG. 3]) of the solar thermal system (1). The flow conditions and the expected energy yield at the installation site ultimately determine the number of and position in which the airflow energy system (5) must be installed.

Experience and measurements of the local airflow conditions, as well as the size or type of solar system and the resulting absorption flows, are used in the design and optimization of the invention.

Software is used to combine the aforementioned design criteria, existing solar radiation, airflow conditions and energy yield, with the necessary calculations to achieve an optimum result for the system configuration.

The modular concept offers the option of using different drum wheels (3) so that optimization can be adapted to the flow conditions. These drum wheels (3) are provided with different geometries of wind vanes (7). For example, in the central area of the solar systems, drum wheels (6) can be used for absorption or thermal flows and in the peripheral areas drum wheels (3) can be used for lateral wind flows.

Another option for optimizing the airflow system is the targeted use of various flow catchers (2).

These flow catchers (2) provide the individual drum wheels (6) with different flow feeds or deflections. This further optimizes the air flow energy system according to the respective flows acting on the solar system.

The invention is designed to be integrated into installations of solar systems (1) regardless of their vertical, angular, or horizontal position.

### Advantageous Effects

Economical additional energy management, on solar systems such as photovoltaic or solar thermal systems, can be achieved with the airflow energy system (5) at any possible installation location.

By using the invention, economic considerations for installations of solar systems (1) will provide better results for the overall energy balance. This results in solar system installations that would previously not have been economical, i.e., without the integration of the invention.

By retrofitting the invention to existing solar systems (1), positive overall energy balances of the systems can be achieved due to the higher energy generation yields.

Another advantage of the invention is that the overall system also supplies power at times of low or unusable solar radiation.

The extent of the increase in efficiency depends on the configuration of the airflow energy system and the airflow conditions at the installation site of the solar thermal systems (1). Due to the modular concept of the invention, the system can be flexibly adapted or optimized according to the prevailing airflow conditions at the installation site, the size of the solar system, and the self-emitting absorption flows.

Another advantage is that the invention does not require a separate installation site. The fact that no investment costs are incurred due to the use of additional land has a positive effect on the efficiency calculation of the overall system.

The airflow energy system can be retrofitted to existing solar thermal systems (1). The additional power generation can be integrated into the existing system control concept. The power storage system may need to be expanded or adapted to the energy yield result.

For new installations of solar systems and airflow energy systems (5) as a uniform overall system, only one system is required for control.

### BRIEF DESCRIPTION OF THE FIGURES

Views of the structure and their installation situations of the airflow generators (5) on a standard framework (2) of solar systems (1)

FIG. 1: a perspective installation situation of an airflow generator system in vertical orientation of the solar system (1)

FIG. 2: a perspective installation situation of an airflow generator system in horizontal orientation of the solar system (1)

FIG. 3: a perspective installation situation of an airflow generator system

FIG. 4: a detailed perspective view of an airflow generator (5) with the individual components

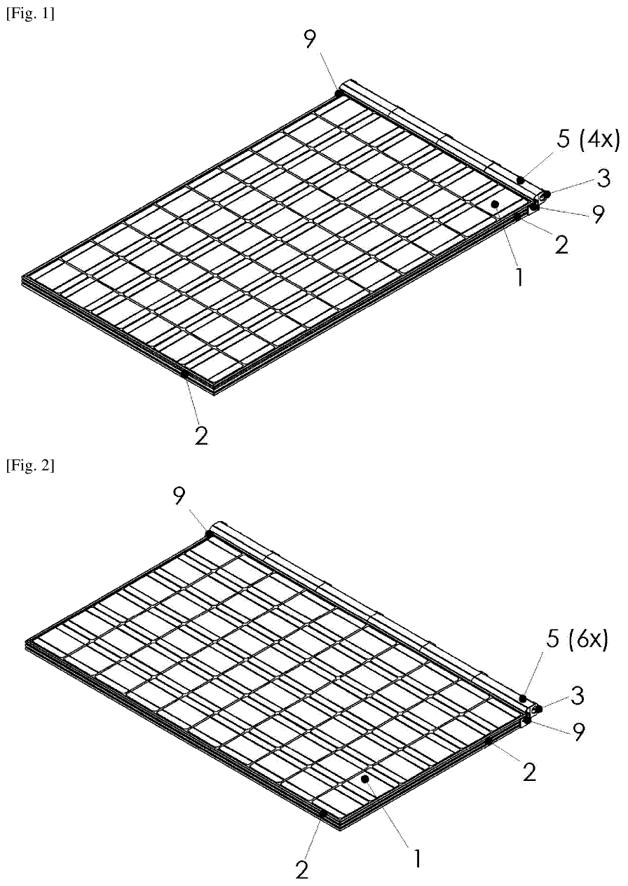

### [FIG. 1]

This figure shows the arrangement of at least one airflow generator (5) on a vertically installed solar thermal system (1) with a standard framework (2). However, no support structures are shown because the installation of my invention works independently of the support structures. The figure is intended to convey the impression that the installation concept allows a simple combination of a solar system (1) and airflow generators (5) to be attached to the standard framework (2) using the adapters (9). Furthermore, it can be seen that the modular design means that multiple individual modules of airflow generators (5)—four in this figure, as an example—can be installed next to each other so that all of the solar system's effective airflows can be utilized.

### [FIG. 2]

This figure shows the arrangement of at least one airflow generator system on a horizontally installed solar thermal system (1) with a standard framework (2). However, no support structures are shown because the installation of my invention works independently of the support structures. This figure is also intended to convey the impression that the installation concept allows a simple combination of a solar system (1) and airflow generators (5) to be attached to the standard framework (2) using the adapters (9). Furthermore, it can also be seen in this figure that the modular design means that multiple individual modules of airflow generators (5)—six in this figure, as an example—can be installed next to each other in the system.

As already shown in [FIG. 1] but also in [FIG. 2], this figure shows how the modular design of the airflow generator system can be optimized for all installation situations.

### [FIG. 4]

This figure shows the arrangement of a maximum configuration of an airflow generator system on a horizontally installed solar thermal system (1) with a standard framework (2). This figure is intended to show that the installation concept enables a simple combination of a solar system (1) with the modular design of airflow generators (5) on all sides. This installation shows that the airflow generators (5) or the system can be installed regardless of the position. In this figure, a total of 20 pieces have been installed, as an example. It is therefore shown how the modular design of the airflow generator system can enable optimization in all installation positions.

### [FIG. 4]

This figure shows the vision of a design to illustrate the principle of modular airflow generators (5). The detailed illustration shows an example of a wind vane (7) which is attached or arranged on a drum wheel. As already described, the drum wheel can be fitted with different geometries of wind catchers. The figure also shows how the rotor axle (4) can be guided through the bearing block to achieve the necessary rotary movement. The generator coil located in the bearing block is not shown in this figure.

The figure also shows the flow catcher (8) already described. These flow catchers also have different geometries, which can be installed on the airflow generators (5).

### Examples

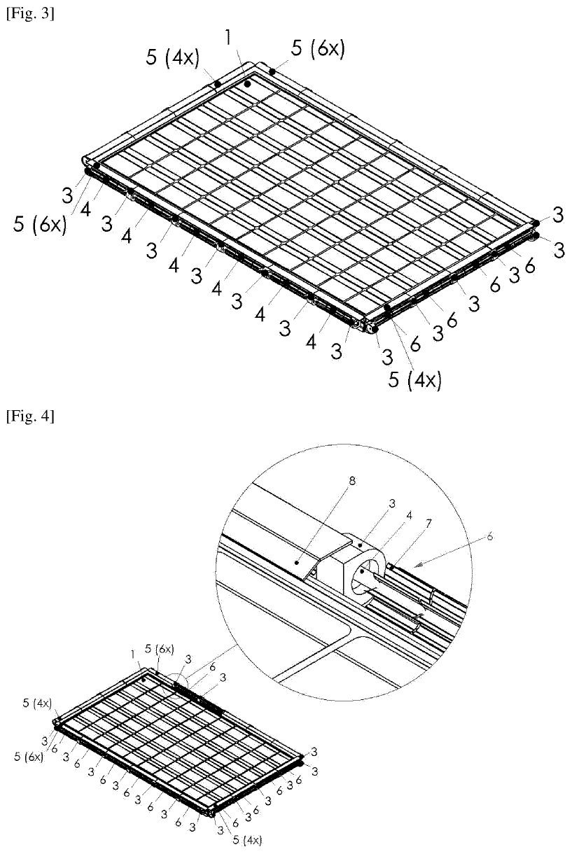

Since only different adapters (9) are required for the installation and operation of my invention, no difference can be visibly depicted in a figure when integrated in a solar thermal system or installed in a solar system (photovoltaic system) (1). This means that there is no need for an additional illustration of the airflow generator system installation variant on a solar thermal system. However, it should be reaffirmed that a solar thermal system as shown in [FIG. 1], [FIG. 2] and [FIG. 3] can also be fully equipped and implemented.

### INDUSTRIAL APPLICABILITY

All specialist companies that sell solar systems could also market this invention and install it after training. Integration into the system control is easy to integrate and can also be carried out by specialist companies.

### LIST OF REFERENCE SYMBOLS

1. Solar system in a conventional design with solar modules (photovoltaic system)
2. Standard frame construction
3. Bearing block arranged laterally or centrally
4. Rotor-axle drum wheel
5. Airflow generator (consisting of 3+4+6+7+8)
6. Drum wheel
7. Wind vane
8. Flow catcher
9. Adapter

### Reference to Deposited Biological Material

### Sequence Listing—Free Text

### List of the Specified Documents

### PATENT DOCUMENTS

patcitl:

### Non-Patent Literature

nplcitl:

1. An airflow energy conversion as an attachment integration in solar systems for the automatic use of all airflows and their directions on the modular drum wheels (6) is achieved by means of the wind vanes' (7) own rotatable bearing and the movable flow catchers (8)
a solar energy system (1) having conventional standard framework (2) containing at least one solar module for generating useful energy from the sun
at least one modular drum wheel generator (5) installed on a solar system (1) to absorb all airflows acting in the environment and on the system installation
resulting in a direction-independent installation option for the wind booster system in an overall system installation consisting of both useful energies for joint use of the hybrid system control.

2. The system as claimed in claim 1, characterized in that, the rotatable bearing of the wind vanes (7) makes it possible to ensure all installation positions of the wind booster systems (FIG. 4).

3. The system as claimed in claim 1, characterized in that, due to the separate bearing of the wind vanes (7), different numbers thereof can be accommodated on the drum wheels (6).

4. The system as claimed in claim 1, characterized in that, due to the separate bearing of the wind vane (7), flexible mounting of different geometries can be positioned on the drum wheels (6).

5. The system as claimed in claim 1, characterized in that, the modular design of the drum generators (5) enables a flexible or different configuration of a hybrid system installation.

6. The system as claimed in claim 1, characterized in that, the movable flow catchers (8) automatically adapt to the airflow conditions and thus optimize the overall harvesting of wind energy at the modular drum generators (5).

7. (canceled)

8. (canceled)

9. (canceled)

10. (canceled)

11. (canceled)

12. (canceled)

13. (canceled)

14. (canceled)

15. (canceled)

16. (canceled)
